(19) United States
(12) Patent Application Publication
(10) Pub. No.: US 2024/0379044 A1
(43) Pub. Date: Nov. 14, 2024

(54) DISPLAY DEVICE AND DRIVING METHOD OF THE SAME

(71) Applicant: LG Display Co., Ltd., Seoul (KR)

(72) Inventors: Jae Gyun OH, Paju-si (KR); Woo Seok DO, Paju-si (KR)

(21) Appl. No.: 18/656,931

(22) Filed: May 7, 2024

(30) Foreign Application Priority Data
May 10, 2023 (KR) 10-2023-0060425

(51) Int. Cl. G09G 3/20; G09G 3/3241

(52) U.S. Cl. CPC G09G 3/2096; G09G 3/3241; G09G 2300/0842; G09G 2310/061; G09G 2310/08; G09G 2320/045; G09G 2330/12; G09G 2370/08

(57) ABSTRACT

Disclosed is a display device including a display panel for displaying images, a driver for driving the display panel, and a timing controller for controlling the driver, wherein the timing controller changes a driving frequency while omitting a period during which black is displayed on the display panel on the basis of at least one first signal transmitted from the outside through a communication method.

### CROSS-REFERENCE TO RELATED APPLICATION(S)

This application claims the benefit of Korean Patent Application No. 10-2023-0060425, filed on May 10, 2023, which is hereby incorporated by reference as if fully set forth herein.

### BACKGROUND

### Technical Field

The present disclosure relates to a display device and a method of driving the same.

### Description of the Related Art

As information technology develops, the market for display devices, which are communication media between users and information, is growing. Accordingly, display devices such as a light emitting display (LED) device, a quantum dot display (QDD) device, and a liquid crystal display (LCD) device are increasingly used.

The display devices described above include a display panel including subpixels, a driver outputting driving signals for driving the display panel, and a power supply for generating power to be supplied to the display panel or the driver.

In such display devices, when driving signals, for example, a scan signal and a data signal, are supplied to subpixels formed in a display panel, selected subpixels transmit light or directly emit light, thereby displaying an image.

### BRIEF SUMMARY

The present disclosure is directed to a display device and a method of driving the same that, among others, substantially obviate one or more problems due to limitations and disadvantages of the related art.

The present disclosure provides a display device capable of continuous screen operation at the time of changing a driving frequency, maintaining user's immersion by switching screens without delay, and allowing compensation to be performed or not performed in consideration of a sufficient compensation time to prevent erroneous compensation due to inaccurate sensing values.

Additional technical characteristics, improvements, and features of the present disclosure will be set forth in part in the description which follows and in part will become apparent to those having ordinary skill in the art upon examination of the following or may be learned from practice of the present disclosure. The technical characteristics and other improvements of the present disclosure may be realized and attained by the structure particularly pointed out in the written description and claims hereof as well as the appended drawings.

As embodied and broadly described herein, a display device includes a display panel for displaying images, a driver for driving the display panel, and a timing controller for controlling the driver, wherein the timing controller changes a driving frequency while omitting a period during which black is displayed on the display panel on the basis of at least one first signal transmitted from the outside through a communication method.

The timing controller may change the driving frequency having a period during which black is displayed on the display panel on the basis of a second signal transmitted through a communication method different from the communication method of the first signal.

The timing controller may generate a mute-off signal for forcibly omitting the period during which black is displayed on the display panel in addition to a driving mode switching signal for changing the driving frequency.

At least one of the first signal and the second signal may be applied in a blank period, which refers to a period in which no image is displayed on the display panel.

A display module including the display panel, the driver, and the timing controller may sense elements included in subpixels of the display panel and compensate for data signals to compensate for deterioration of the elements.

The timing controller may count a data enable signal applied from the outside, determine whether time conditions to sense the elements are met when the driving frequency is switched, and control a sensing operation for sensing the elements to be skipped if the time conditions to sense the elements are not met.

The timing controller may control sensing line initialization for discarding sensing values acquired during a frame in which the sensing operation has been skipped and performing initialization to be performed in addition to skipping of the sensing operation.

In another aspect of the present disclosure, a method of driving a display device includes displaying an image on a display module including a display panel, a driver for driving the display panel, and a timing controller for controlling the driver, and applying a signal to the timing controller to change a driving frequency of the display module, wherein the changing of the driving frequency of the display module comprises changing the driving frequency of the display module while omitting a period during which black is displayed on the display panel on the basis of at least one first signal.

At least one of the first signal and a second signal may be applied in a blank period defined as a period in which no image is displayed on the display panel.

The method may further include sensing elements included in subpixels of the display panel in the display module, and compensating for data signals to compensate for deterioration of the elements.

The sensing of the elements may include counting a data enable signal applied from the outside, determining whether time conditions to sense the elements are met when the driving frequency is switched, and controlling a sensing operation for sensing the elements to be skipped if the time conditions to sense the element are not met.

The sensing of the elements may include controlling sensing line initialization for discarding sensing values acquired during a frame in which the sensing operation has been skipped and performing initialization to be performed in addition to skipping of the sensing operation.

It is to be understood that both the foregoing general description and the following detailed description of the present disclosure are illustrative and explanatory and are intended to provide further explanation of the present disclosure.

### BRIEF DESCRIPTION OF THE SEVERAL VIEWS OF THE DRAWINGS

The accompanying drawings, which are included to provide a further understanding of the present disclosure and are incorporated in and constitute a part of this application, illustrate embodiment(s) of the present disclosure and together with the description serve to explain the principle of the present disclosure. In the drawings:

FIG. 1 is a block diagram schematically showing a light emitting display device, FIG. 2 is a configuration diagram schematically showing a subpixel shown in FIG. 1, and FIG. 3 is a diagram showing a pixel composed of subpixels;

FIG. 4 and FIG. 5 are diagrams illustrating the configuration of a gate-in-panel scan driver, and FIG. 6 is a diagram showing an example of the arrangement of the gate-in-panel scan driver;

FIG. 7 is a diagram showing a subpixel and a data driver according to a first embodiment of the present disclosure, and FIG. 8 is a diagram showing components included in the data driver according to the first embodiment of the present disclosure in more detail;

FIG. 9 is a diagram showing changing a driving frequency of a display panel according to the first embodiment of the present disclosure, FIG. 10 is a block diagram showing an image provider and a timing controller according to the first embodiment of the present disclosure, and FIG. 11 is a waveform diagram illustrating parts related to driving frequency change;

FIG. 12 is a first example diagram illustrating operation performed in the timing controller when the driving frequency is changed on the basis of the waveforms of FIG. 11, and FIG. 13 is a second example diagram illustrating operation performed in the timing controller when the driving frequency is changed on the basis of the waveforms of FIG. 11; and

FIG. 14 is a block diagram showing an image provider and a timing controller according to a second embodiment of the present disclosure, and FIG. 15 is a flowchart illustrating a mode switching method according to the second embodiment of the present disclosure.

### DETAILED DESCRIPTION

A display device according to the present disclosure may be implemented as a television system, an image player, a personal computer (PC), a home theater, an automobile electric device, a smartphone, or the like, but is not limited thereto. The display device according to the present disclosure may be implemented as a light emitting display (LED) device, a quantum dot display (QDD) device, a liquid crystal display (LCD) device, or the like. However, for convenience of description, as an example, a light emitting display device that directly emits light based on inorganic light emitting diodes or organic light emitting diodes will be described below.

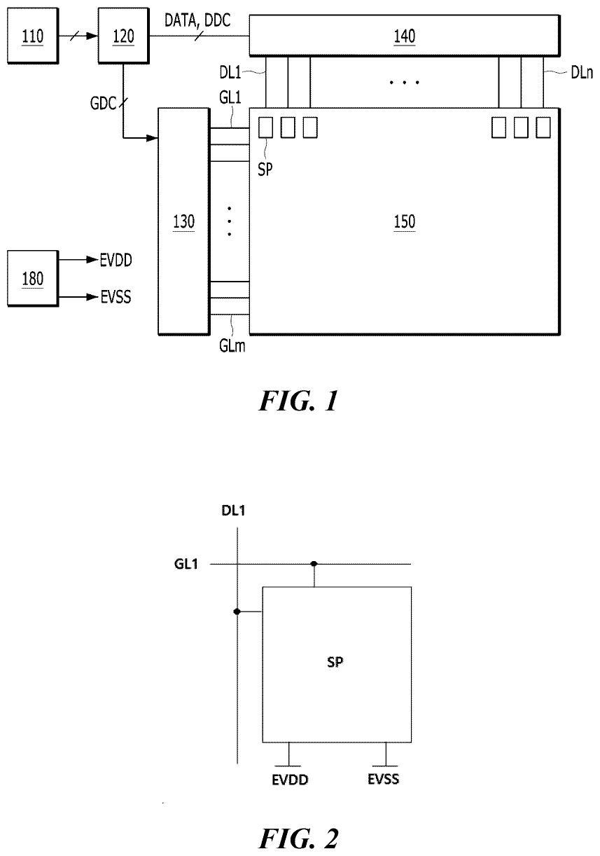

FIG. 1 is a block diagram schematically showing a light emitting display device, FIG. 2 is a configuration diagram schematically showing a subpixel shown in FIG. 1, and FIG. 3 is a diagram showing a pixel composed of subpixels.

As illustrated in FIG. 1, FIG. 2, and FIG. 3, the light emitting display device may include an image provider 110, a timing controller 120, a scan driver 130, a data driver 140, a display panel 150, a power supply 180, and the like.

An image provider 110 (a set or a host system) may output various driving signals along with an externally supplied image data signal or an image data signal stored in an internal memory. The image provider 110 may supply data signals and various driving signals to the timing controller 120.

The timing controller 120 may output a gate timing control signal GDC for controlling the operation timing of the scan driver 130, a data timing control signal DDC for controlling the operation timing of the data driver 140, and various synchronization signals. The timing controller 120 may supply a data signal DATA supplied from the image provider 110 to the data driver 140 along with the data timing control signal DDC. The timing controller 120 may be implemented in the form of an integrated circuit (IC) and mounted on a printed circuit board, but is not limited thereto.

The scan driver 130 may output a scan signal (or a scan voltage) in response to the gate timing control signal GDC supplied from the timing controller 120. The scan driver 130 may supply scan signals to subpixels included in the display panel 150 through gate lines GL1 to GLm. The scan driver 130 may be implemented in the form of an IC or directly formed on the display panel 150 in a gate-in-panel structure, but is not limited thereto.

The data driver 140 may sample and latch the data signal DATA in response to the data timing control signal DDC supplied from the timing controller 120, convert the digital data signal into an analog data voltage on the basis of a gamma reference voltage, and output the analog data voltage. The data driver 140 may supply data voltages to the subpixels included in the display panel 150 through data lines DL1 to DLn. The data driver 140 may be implemented in the form of an integrated circuit (IC) and mounted on the display panel 150 or mounted on a printed circuit board, but is not limited thereto.

The power supply 180 can generate first power at a high level and second power at a low level on the basis of an external input voltage supplied from the outside. The power supply 180 may output the first power through a first power line EVDD and output the second power through a second power line EVSS. The power supply 180 may generate and output voltages (e.g., a scan high voltage and a scan low voltage) to drive the scan driver 130 and voltages (e.g., a drain voltage and a half drain voltage) to drive the data driver 140 as well as the first power and the second power.

The display panel 150 may display an image in response to driving signals including a scan signal and a data voltage, the first power, and the second power. The subpixels of the display panel 150 may directly emit light. The display panel 150 may be manufactured based on a substrate having rigidity or flexibility, such as glass, silicon, polyimide, or the like. For example, one subpixel SP may be connected to the first data line DL1, the first gate line GL1, the first power line EVDD, and the second power line EVSS and may include a pixel circuit including a switching transistor, a driving transistor, a capacitor, an organic light emitting diode, etc.

Subpixels SP used in the light-emitting display device directly emit light, and thus the circuit configuration thereof is complicated. In addition, there are various compensation circuits that compensate for deterioration of not only the organic light emitting diode emitting light but also the driving transistor that supplies a driving current to drive the organic light emitting diode. Therefore, the subpixel SP is simply shown in the form of a block.

Subpixels emitting light may be composed of red, green, and blue pixels or red, green, blue, and white pixels. For example, one pixel P may include a red subpixel SPR connected to the first data line DL1, a white subpixel SPW connected to the second data line DL2, a green subpixel SPG connected to the third data line DL3, and a blue subpixel SPB connected to the fourth data line DL4. Additionally, the red subpixel SPR, white subpixel SPW, green subpixel SPG, and blue subpixel SPB may be commonly connected to a first reference line VREF1. The first reference line VREF1 may be used to sense deterioration of elements included in one of the red subpixel SPR, white subpixel SPW, green subpixel SPG, and blue subpixel SPB, which will be described below.

Meanwhile, the timing controller 120, the scan driver 130, and the data driver 140 have been described as individual components. However, depending on the implementation method of the light emitting display device, one or more of the timing controller 120, the scan driver 130, and the data driver 140 may be integrated into a single IC. In addition, as an example, the pixels P in which the red subpixel SPR, white subpixel SPW, green subpixel SPG, and blue subpixel SPB are arranged in order has been illustrated. However, the arrangement order and direction of subpixels may vary depending on the implementation method of the light emitting display device.

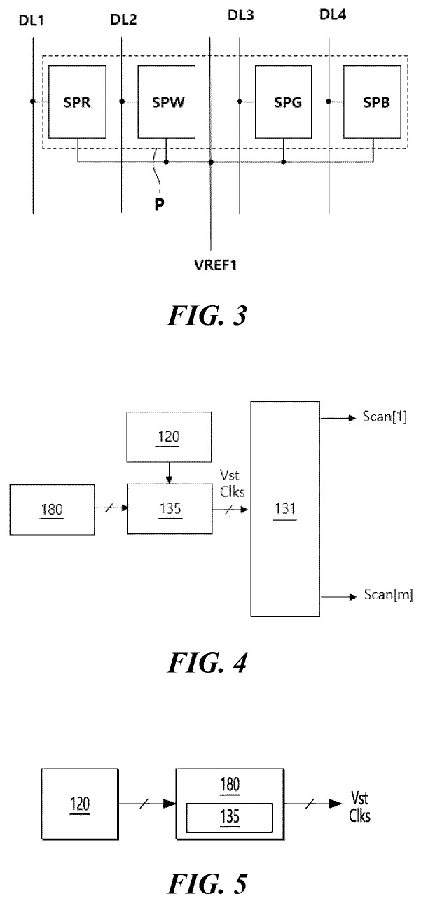

FIG. 4 and FIG. 5 are diagrams illustrating the configuration of a gate-in-panel type scan driver, and FIG. 6 is a diagram showing an example of the arrangement of the gate-in-panel type scan driver.

As shown in FIG. 4, the gate-in-panel type scan driver may include a shift register 131 and a level shifter 135. The level shifter 135 may generate driving clock signals Clks and a start signal Vst on the basis of signals and voltages output from the timing controller 120 and the power supply 180.

The shift register 131 operates on the basis of signals Clks and Vst output from the level shifter 135, and may output scan signals Scan[1] to Scan[m] for turning on or off transistors formed in the display panel. The shift register 131 may take the form of a thin film on the display panel in a gate-in-panel structure.

As shown in FIG. 4 and FIG. 5, unlike the shift register 131, the level shifter 135 may be formed independently in the form of an IC or may be included in the power supply 180. However, this is merely an example and is not limited to thereto.

As shown in FIG. 6, shift registers 131a and 131b that output scan signals in the gate-in-panel type scan driver may be disposed in a non-display area NA of the display panel 150. As an example, the shift registers 131a and 131b are disposed in the left and right non-display areas NA of the display panel 150, but the shift registers 131a and 131b may also be disposed in upper and lower non-display areas NA of the display panel 150 or may be disposed within a display area AA of the display panel 150.

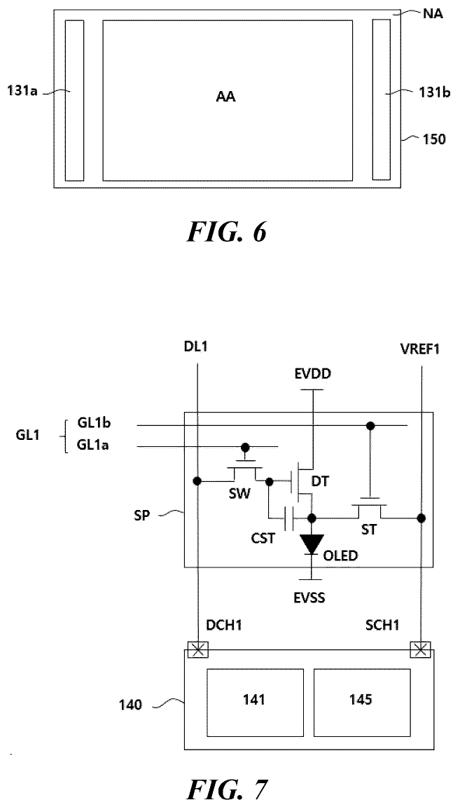

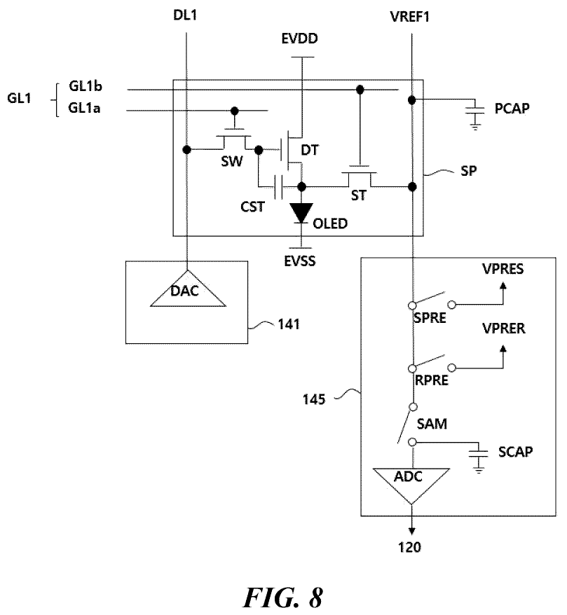

FIG. 7 is a diagram showing a subpixel and a data driver according to a first embodiment of the present disclosure, and FIG. 8 is a diagram showing components included in the data driver according to the first embodiment of the present disclosure in more detail.

As shown in FIG. 7, one subpixel SP may include a switching transistor SW, a driving transistor DT, a sensing transistor ST, a capacitor CST, and an organic light emitting diode OLED.

The driving transistor DT may include a gate electrode connected to a first electrode of the capacitor CST, a first electrode connected to the first power line EVDD, and a second electrode connected to the anode of the organic light emitting diode OLED. The capacitor CST may have the first electrode connected to the gate electrode of the driving transistor DT and a second electrode connected to the anode electrode of the organic light emitting diode OLED. The organic light emitting diode OLED may have the anode connected to the second electrode of the driving transistor DT and a cathode connected to the second power line EVSS.

The switching transistor SW may include a gate electrode connected to a first scan line GL1a included in the first gate line GL1, a first electrode connected to the first data line DL1, and a second electrode connected to the gate electrode of the driving transistor DT. The sensing transistor ST may include a gate electrode connected to a second scan line GL1b included in the first gate line GL1, a first electrode connected to the first reference line VREF1, and a second electrode connected to the anode of the organic light emitting diode OLED.

The sensing transistor ST is a kind of compensation circuit added to compensate for deterioration of the driving transistor DT or the organic light emitting diode OLED. The sensing transistor ST can enable physical threshold voltage sensing based on the source follower operation of the driving transistor DT. The sensing transistor ST can operate to acquire a sensing voltage through a sensing node defined between the driving transistor DT and the organic light emitting diode OLED. Meanwhile, the first gate line GL1 may not be divided into the first scan line GL1a and the second scan line GL1b, and may be integrated into one. That is, the switching transistor SW and the sensing transistor ST may be commonly connected to the first gate line GL1 and turned on or off at the same time.

The data driver 140 may include a driving circuit 141 for driving the subpixel SP and a sensing circuit 145 for sensing the subpixel SP. The driving circuit 141 may be connected to the first data line DL1 through a first data channel DCH1 and to the first reference line VREF1 through a first sensing channel SCH1. The driving circuit 141 may output a data voltage for driving the subpixel SP through the first data channel DCH1. The sensing circuit 145 may acquire a sensing voltage sensed from the subpixel SP through the first sensing channel SCH1.

As shown in FIG. 8, the driving circuit 141 may include a digital-to-analog converter DAC to output a sensing data voltage, a black data voltage, or a display data voltage. The sensing circuit 145 may include a first voltage circuit SPRE, a second voltage circuit RPRE, a sampling circuit SAM, and an analog-to-digital converter ADC to output a voltage to the subpixel SP and the first reference line VREF1 and sense a voltage.

The first voltage circuit SPRE and the second voltage circuit RPRE may perform a voltage output operation to initialize nodes or circuits included in the subpixel SP or charge the same with a specific level of voltage. The first voltage circuit SPRE and the second voltage circuit RPRE may include a first reference voltage source VPRES and a second reference voltage source VPRER, respectively. The first voltage circuit SPRE may output a first reference voltage based on the first reference voltage source VPRES, and the second voltage circuit RPRE may output a second reference voltage based on the second reference voltage source VPRER. The first reference voltage may be defined as a voltage for use in a sensing mode (compensation mode) for deterioration compensation, and the second reference voltage may be defined as a voltage for use in a driving mode (normal mode) for image display. Further, the first reference voltage may be set to a voltage lower than the second reference voltage.

The sampling circuit SAM can perform a sampling operation to acquire a sensing voltage through the first reference line VREF1. The analog-to-digital converter ADC can convert the analog sensing voltage acquired by the sampling circuit SAM into a digital sensing voltage and output the digital sensing voltage. The analog-to-digital converter ADC may change the scale (scale up or scale down) to easily convert the sensing voltage stored in a sampling capacitor (SCAP).

The sensing circuit 145 may acquire a sensing voltage for compensating for deterioration of the driving transistor DT or the organic light emitting diode OLED included in the subpixel SP through a sensing capacitor PCAP formed on the first reference line VREF1. The sensing circuit 145 may acquire the sensing voltage through the sampling capacitor SCAP formed in the sampling circuit SAM, convert the analog sensing voltage acquired through the analog-to-digital converter ADC into a digital sensing voltage, and output the digital sensing voltage. The sensing voltage output from the sensing circuit 145 may be transmitted to the timing controller 120. The timing controller 120 may determine whether the driving transistor DT or the organic light emitting diode OLED included in the subpixel SP has deteriorated on the basis of the sensing voltage and perform a compensation operation for compensating for the deterioration.

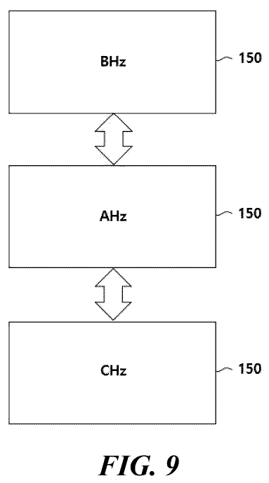

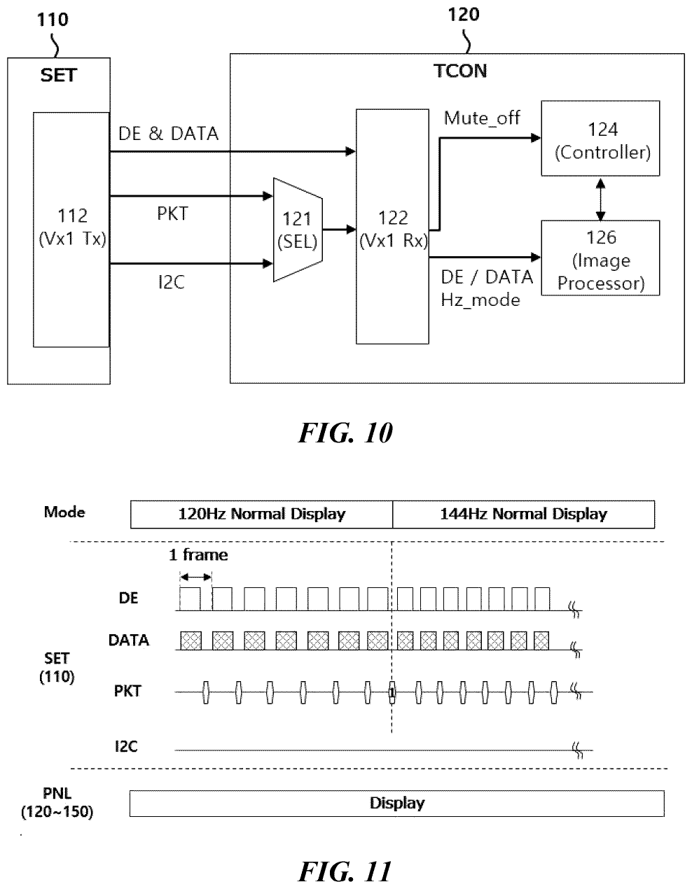

FIG. 9 is a diagram showing changing a driving frequency of a display panel according to the first embodiment of the present disclosure, FIG. 10 is a block diagram showing an image provider and a timing controller according to the first embodiment of the present disclosure, and FIG. 11 is a waveform diagram illustrating parts related to driving frequency change.

As shown in FIG. 9, the driving frequency of the display panel 150 may be changed from a first frequency AHz to a second frequency BHz, from the first frequency AHz to a third frequency CHz, from the second frequency BHz to the third frequency CHz, or from the third frequency CHz to the second frequency BHz. Here, the relationship among the first frequency AHz, the second frequency BHz, and the third frequency CHz may be AHz<BHz<CHz. Although only three frequencies of low rate AHz, medium rate BHz, and high rate CHz are mentioned in FIG. 9, there may be M (M being an integer of 2 or more) frequencies other than three that can be varied or selected among. That is, the display panel 150 can operate based on various driving frequencies depending on a driving mode switching signal that can be used between devices included in the light emitting display device.

As shown in FIG. 10, the light emitting display device according to the first embodiment of the present disclosure may include an image provider (SET) 110, a timing controller (TCON) 120, and the like as components for operation of the display panel. For example, the image provider 110 and the timing controller 120 may be connected through a communication interface called Vx1.

The image provider 110 may include a signal transmission circuit (Vx1 TX) 112, and the like. The signal transmission circuit 112 is a circuit for transmitting a data enable signal DE, a data signal DATA, a control packet signal PKT, an I2C signal I2C, and the like through an interface connected to the timing controller 120. The data enable signal DE can be defined as a signal that allows output of the data signal DATA. The data enable signal DE, the data signal DATA, and the control packet signal PKT may be transmitted through a first communication method (differential voltage communication method), and the I2C signal I2C may be transmitted through a second communication method (serial communication method) different from the first communication method.

The timing controller 120 may include a selection circuit (SEL) 121, a signal reception circuit (Vx1 Rx) 122, a controller 124, and an image processor 126. The controller 124 and the image processor 126 are separated for functional purposes only, and both may be defined as one circuit. Meanwhile, the image processor 126 may generate a compression signal for compressing data 1 frame in advance at the time of driving mode switching for stable communication (data transmission and reception) with a DDR memory operating in association with the timing controller 120.

The selection circuit (SEL) 121 may transmit a selected one of the control packet signal PKT and the I2C signal I2C to the signal reception circuit 122. For example, the selection circuit 121 does not receive a separate selection signal, and may select one of the control packet signal PKT and the I2C signal I2C (select the corresponding signal if there is preset data) on the basis of analysis of data included in the control packet signal PKT and the I2C signal I2C and transmit the selected signal to the signal reception circuit 122.

The signal reception circuit 122 may receive the data enable signal DE and the data signal DATA along with the one selected from the control packet signal PKT and the I2C signal I2C. The signal reception circuit 122 may generate a driving mode switching signal Hz_mode and a mute-off signal Mute_off on the basis of the one selected from the control packet signal PKT and the I2C signal I2C.

The controller 124 can control devices included in the timing controller 120. The controller 124 may set operation timings of the devices and set a compensation timing for determining and performing compensation for the data signal DATA on the basis of an internal scheduler. Meanwhile, the controller 124 may limit output (stop output of a black data signal) such that the black data signal is not output from the timing controller 120 in response to the mute-off signal Mute_off output from the signal reception circuit 122.

The image processor 126 may operate in association with the controller 124 to perform image processing on a signal input to the timing controller 120. The image processor 126 may perform image processing for compensating for the data signal DATA on the basis of the data enable signal DE and the mode change signal Hz_mode.

As shown in FIG. 10 and FIG. 11, the driving mode of the light emitting display device can be changed to display a normal image at 120 Hz (120 Hz Normal Display) and then display a normal image at 144 Hz (144 Hz Normal Display).

The timing controller 120 may change the driving mode on the basis of a signal included in one of the control packet signal PKT and the I2C signal I2C output from the image provider (SET) 110.

According to a first example, the image provider (SET) 110 may load a first signal for performing driving mode switching, for example, a bit signal of 1 (here, 1 is merely a number for aiding in understanding and the bit signal may be configured in various forms), on the control packet signal PKT and output the same during a period in which the data enable signal DE or the data signal DATA is not output, for example, a blank period. Here, the blank period may correspond to a period having a low signal even in one frame period. When the first signal for performing driving mode switching is loaded on the control packet signal PKT and output in this manner, a second signal for performing driving mode switching may not be present in the I2C signal I2C.

When the first signal loaded on the control packet signal PKT output from the image provider 110 is output, a panel module PNL including the timing controller 120 to the display panel 150 can display an image in response to the changed driving frequency without a black mute operation (an operation of displaying black data on the display panel) for mode switching. In other words, at the time of changing the driving frequency, a separate black mute operation can be forcibly omitted (removed).

According to a second example, the image provider (SET) 110 may load the second signal for performing driving mode switching in the I2C signal I2C and output the same during a period in which the data enable signal DE or the data signal DATA is not output, for example, the blank period. When the second signal for performing driving mode switching is loaded in the I2C signal I2C and output in this manner, the first signal for performing driving mode switching may not be present in the control packet signal PKT.

When the second signal loaded on the I2C signal I2C output from the image provider 110 is output, the panel module PNL including the timing controller 120 and the display panel 150 can display an image in response to the changed driving frequency along with a separate black mute operation for mode switching. In other words, changing the driving frequency may involve the separate black mute operation.

Meanwhile, as can be ascertained from FIG. 11, when the separate black mute operation is omitted at the time of changing the driving frequency, the panel module PNL can display images continuously without a black frame insertion operation before or after mode switching. In other words, since images can be displayed without interruption even if the driving frequency is changed, the user's immersion can be maintained along with screen switching without delay.

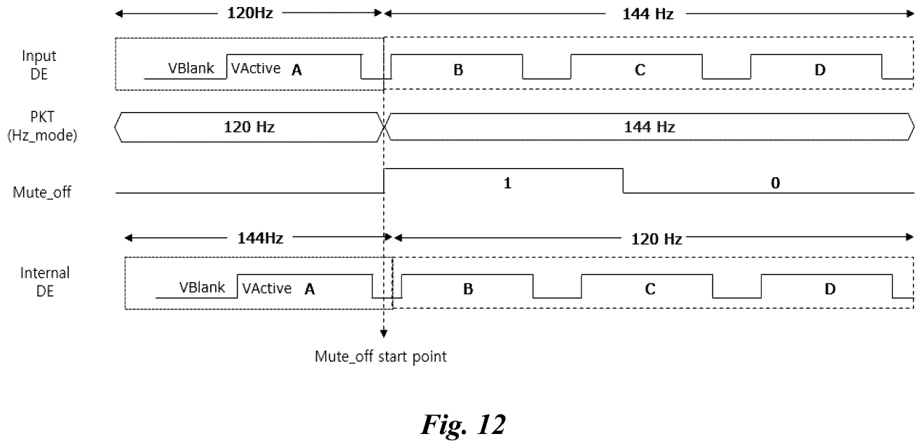

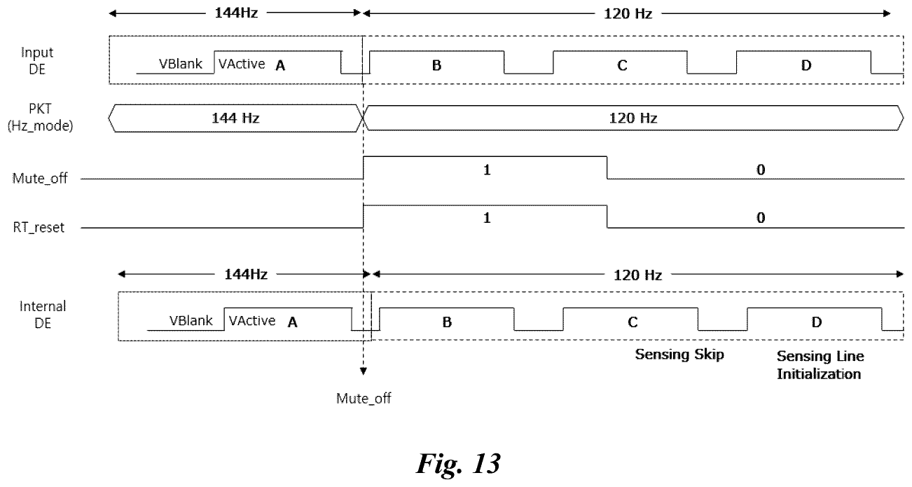

FIG. 12 is a first example diagram illustrating operation performed in the timing controller when the driving frequency is changed on the basis of the waveforms of FIG. 11, and FIG. 13 is a second example diagram illustrating operation performed in the timing controller when the driving frequency is changed on the basis of the waveforms of FIG. 11.

The timing controller may determine and perform compensation for a data signal in order to compensate for deterioration of elements included in subpixels of the display panel. The first example shown in FIG. 12 is an example considering conditions in which compensation for deterioration of elements included in subpixels of the display panel is not required, and the second example shown in FIG. 13 is an example considering conditions in which compensation for deterioration of elements included in subpixels of the display panel is required.

As shown in FIG. 10, FIG. 12, and FIG. 13, the data enable signal DE may be divided into an input data enable signal Input DE and an internal data enable signal Internal DE. The input data enable signal Input DE may be defined as a signal output from the image provider 110 and input to the timing controller 120. The internal data enable signal Internal DE may be defined as a signal generated in the timing controller 120.

The internal data enable signal Internal DE may be generated internally in the timing controller 120 or may be generated on the basis of the input data enable signal Input DE. Therefore, the internal data enable signal Internal DE is generated with a slight delay time compared to the input data enable signal Input DE, and thus there may be a time difference corresponding to Δt.

During an active period VActive of 120 Hz, the driving mode switching signal Hz_mode can be input to drive the display panel at a driving frequency of 120 Hz, and during an active period VActive of 144 Hz, the driving mode switching signal Hz_mode can be input to drive the panel at a driving frequency of 144 Hz.

As described above, the signal for performing driving mode switching is applied during a blank period VBlank, and thus the driving mode switching signal Hz_mode can be applied (changed) during a blank period VBlank between frame A and frame B.

When the first signal is applied as a signal for performing driving mode switching, the signal reception circuit 122 may output the mute-off signal MUTE_off such that an image can be displayed in response to the changed driving frequency without a separate black mute operation (an operation of displaying black data on the display panel). Here, an example in which the mute-off signal Mute_off is temporarily output as a signal corresponding to high (1) and then output as a signal corresponding to low (0) is illustrated, but the mute-off signal Mute_off may be temporarily output as a signal corresponding to low (0) and then output as a signal corresponding to high (1).

Meanwhile, when compensation for deterioration of elements included in the subpixels of the display panel is required, as in the second example shown in FIG. 13, the timing controller 120 may generate a sensing reset signal RT_reset in addition to the mute-off signal Mute_off.

The timing controller 120 may count the internal data enable signal Internal DE, determine whether sufficient time conditions or thresholds are available to compensate for deterioration of elements, and then generate the sensing reset signal RT_reset according to the determination result. At this time, as in the second example shown in FIG. 13, the fact that the sensing reset signal RT_reset is generated in the same way as the mute-off signal Mute_off may correspond to a case where sufficient time conditions are not available to compensate for deterioration of elements.

The fact that the sensing reset signal RT_reset is generated along with driving mode switching means that sufficient time conditions are not available to compensate for deterioration of elements. Therefore, in order to stabilize the compensation operation, the timing controller 120 may control the device such that sensing skip is performed to skip the sensing operation for compensation during frame C following the frame B.

In addition, in order to prevent erroneous compensation due to acquisition of inaccurate sensing values, the timing controller 120 may control the device such that sensing line initialization for discarding sensing values acquired during the frame C in which sensing skip occurs and performing initialization is performed.

Meanwhile, an example in which the sensing reset signal RT_reset is temporarily output as a signal corresponding to high (1) and then output as a signal corresponding to low (0) like the mute-off signal Mute_off is illustrated, but the present disclosure is not limited thereto.

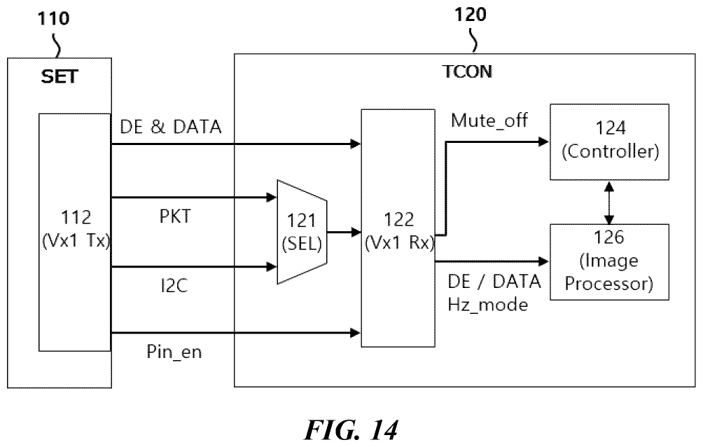

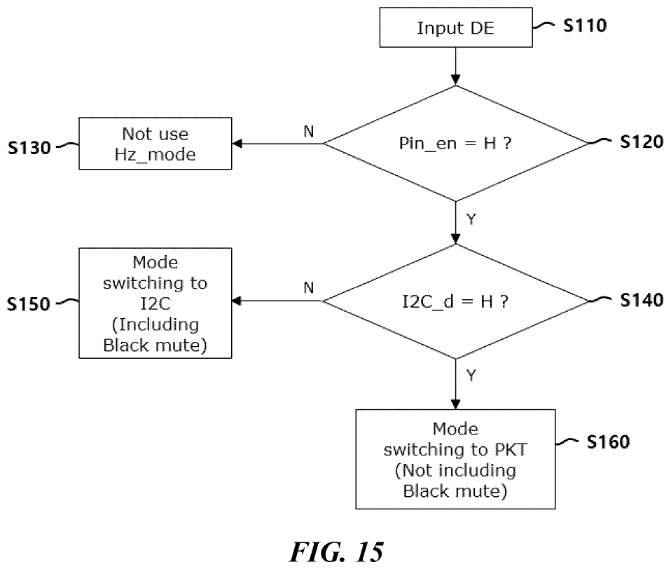

FIG. 14 is a block diagram showing an image provider and a timing controller according to a second embodiment of the present disclosure, and FIG. 15 is a flowchart illustrating a mode switching method according to the second embodiment of the present disclosure.

As shown in FIG. 14, the light emitting display device according to the second embodiment of the present disclosure may include an image provider (SET) 110, a timing controller (TCON) 120, and the like as components for operation of a display panel. Since the configurations of the image provider 110 and the timing controller 120 are similar to those described in the first embodiment, the first embodiment is referred to. Therefore, differences from the first embodiment will be mainly described.

According to the second embodiment, the signal transmission circuit 112 of the image provider 110 may generate and output a pin activation signal Pin_en. In addition, the signal reception circuit 122 of the timing controller 120 may receive the pin activation signal Pin_en. The reason for exchanging the pin activation signal Pin_en between the image provider 110 and the timing controller 120 will be described below.

As shown in FIG. 14 and FIG. 15, the signal reception circuit 122 of the timing controller 120 may receive the input data enable signal Input DE transmitted from the image provider 110 and count the same (S110). By counting the input data enable signal Input DE, it is possible to determine whether sufficient time conditions or thresholds are available to perform a sensing and compensation mode for compensating for deterioration of elements. In addition, depending on whether the sensing and compensation mode can be performed, sensing skip or sensing line initialization can be performed as shown in FIG. 13.

The signal reception circuit 122 of the timing controller 120 may determine whether the pin activation signal Pin_en transmitted from the image provider 110 corresponds to logic high (H) (S120).

If the pin activation signal Pin_en does not correspond to logic high (H) (N), the signal reception circuit 122 of the timing controller 120 determines that driving mode switching is not performed and may not generate the driving mode switching signal Hz_mode in order to not use the driving mode switching signal Hz_mode (S130).

If the pin activation signal Pin_en corresponds to logic high (H) (Y), the signal reception circuit 122 of the timing controller 120 may primarily determine that driving mode switching is performed and determine whether a data value I2C_d included in the I2C signal I2C corresponds to logic high (H) (S140).

If the data value I2C_d included in the I2C signal I2C does not correspond to logic high (H) (N), the driving mode can be switched (mode switching to I2C) on the basis of the signal included in the I2C signal I2C (S150). In this case, the timing controller 120 can control the device such that an image is displayed in response to the changed driving frequency while performing a separate black mute operation (including black mute).

On the other hand, if the data value I2C_d included in the I2C signal I2C corresponds to logic high (H) (Y), the driving mode can be switched (mode switching to PKT) on the basis of the signal included in the control packet signal PKT (S160). In this case, the timing controller 120 can control the device such that an image is displayed in response to the changed driving frequency while omitting a separate black mute operation (black mute not included).

Meanwhile, as in the second embodiment, if the separate pin activation signal Pin_en is added, stable synchronization can be achieved compared to the method using only the control packet signal PKT and I2C signal I2C, and thus the driving mode can be switched at more accurate timing. As a result, it is possible to improve the problem of a brief screen error due to misalignment of the input data enable signal Input DE and the I2C signal I2C (timing mismatch that may occur between Input DE and I2C).

The present disclosure has the effect of enabling continuous screen operation at the time of changing a driving frequency and maintaining user's immersion by switching screens without delay. In addition, the present disclosure has the effect of allowing compensation to be performed or not performed in consideration of a sufficient compensation time to prevent erroneous compensation due to inaccurate sensing values.

It will be apparent to those skilled in the art that various modifications and variations can be made in the present disclosure without departing from the spirit or scope of the present disclosure. Thus, it is intended that the present disclosure cover the modifications and variations of the present disclosure.

The various embodiments described above can be combined to provide further embodiments. Aspects of the embodiments can be modified, if necessary to employ concepts of the various embodiments to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A display device comprising:
a display panel for displaying images;
a driver for driving the display panel; and
a timing controller for controlling the driver,
wherein, in operation, the timing controller changes a driving frequency while omitting a period during which black is displayed on the display panel based on at least a first signal transmitted to the timing controller.

2. The display device of claim 1, wherein the timing controller is configured to change the driving frequency and allow a period during which black is displayed on the display panel based on a second signal transmitted to the timing controller through a communication channel different from that of the first signal.

3. The display device of claim 1, wherein the timing controller is configured to generate a mute-off signal for omitting the period during which black is displayed on the display panel in addition to a driving mode switching signal for changing the driving frequency.

4. The display device of claim 2, wherein at least one of the first signal or the second signal is applied in a blank period in which no image is displayed on the display panel.

5. The display device of claim 1, wherein a display module including the display panel, the driver, and the timing controller is configured to sense elements included in subpixels of the display panel and compensate for a data signal to an elements that is determined to have deterioration based on the sensing the elements.

6. The display device of claim 5, wherein the timing controller is configured to count a data enable signal, determine whether a time threshold to sense the elements is met when the driving frequency is switched, and control a sensing operation for sensing the elements to be skipped when the time threshold to sense the elements is not met.

7. The display device of claim 6, wherein the timing controller is configured to control sensing line initialization, the sensing line initialization including:
discarding sensing values acquired during a frame in which the sensing operation has been skipped; and
performing initialization in addition to the skipping the sensing operation.

8. A method of driving a display device, comprising:
displaying an image on a display module including a display panel, a driver for driving the display panel, and a timing controller for controlling the driver; and
applying a signal to the timing controller to change a driving frequency of the display module,
wherein the changing the driving frequency of the display module comprises changing the driving frequency of the display module while omitting a period during which black is displayed on the display panel based on at least a first signal of the signal.

9. The method of claim 8, wherein the applying the signal includes applying at least one of the first signal or a second signal in a blank period in which no image is displayed on the display panel.

10. The method of claim 8, comprising:
sensing elements included in subpixels of the display panel in the display module; and
compensating for a data signal to an element that is determined to have deterioration based on the sensing the elements.

11. The method of claim 10, wherein the sensing the elements comprises:
counting a data enable signal applied to the elements,
determining whether a time threshold to sense the elements is met when the driving frequency is switched, and
controlling a sensing operation for sensing the elements to be skipped when the time threshold to sense the elements is not met.

12. The method of claim 11, wherein the sensing the elements comprises controlling sensing line initialization, the sensing line initialization including:
discarding sensing values acquired during a frame in which the sensing operation has been skipped; and
performing initialization in addition to the skipping the sensing operation.

13. A display device, comprising:
a display panel for displaying images;
a driver for driving the display panel; and
a timing controller for controlling the driver, the timing controller including a selection unit and a signal reception circuit, the selection unit configured to select one of a first signal or a second signal to transmit to the signal reception circuit, and the signal reception circuit configured to issue a control signal to control image displaying with a changed driving frequency based on the selected one of the first signal or the second signal.

14. The display device of claim 13, wherein the selection unit is configured to receive the first signal or the second signal through two different channels.

15. The display device of claim 14, wherein the selection unit is configured to receive the first signal through a differential voltage communication channel.

16. The display device of claim 14, wherein the selection unit is configured to receive the second signal through a serial communication channel.

17. The display device of claim 13, wherein the control signal includes one or more of a first control signal or a second control signal, the first control signal configured to control a driving mode of a driving frequency, and the second control signal configured to control omitting a period during which black is displayed.

18. The display device of claim 17, wherein the signal reception circuit is configured to issue the first control signal and the second control signal in a case that the first signal is received at the signal reception circuit.

19. The display device of claim 17, wherein the signal reception circuit is configured to issue the first control signal without the second control signal in a case that the second signal is received at the signal reception circuit.

20. The display device of claim 17, wherein the first control signal is configured to be applied during a blank period.
